(19) United States
(12) Patent Application Publication
(10) Pub. No.: US 2007/0136402 A1
(43) Pub. Date: Jun. 14, 2007

(54) Automatic prediction of future out of memory exceptions in a garbage collected virtual machine

(75) Inventors: Vanessa J. Grose, Rochester, MN (US); John G. Nistler, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/290,882

(22) Filed: Nov. 30, 2005

(51) Int. Cl. G06F 17/30

(52) U.S. Cl. 707/206

(57) ABSTRACT

A method, article of manufacture and apparatus for automatically predicting out of memory exceptions in garbage collected environments are disclosed. One embodiment provides a method of predicting out of memory events that includes monitoring an amount of memory available from a memory pool during a plurality of garbage collection cycles. A memory usage profile may be generated on the basis of the monitored amount of memory available, and then used to predict whether an out of memory exception is likely to occur.

### BACKGROUND OF THE INVENTION

1. Field of the Invention

Embodiments of the present invention generally relate to the field of computer software. In particular, embodiments of the generally invention relate to, systems, and articles of manufacture for managing memory use in a virtual machine.

2. Description of the Related Art

Currently, computer software applications may be deployed on servers or client computers. Some applications may be executed within an environment provided by a virtual machine. A virtual machine provides an abstract specification for a computing device that may be implemented in different ways. The virtual machine allows a computer program or application to run on any computer platform, regardless of the underlying hardware. Applications compiled for the virtual machine may be executed on any underlying computer system, provided that a version of the virtual machine is available. Typically, the virtual machine is implemented in software rather than hardware and is often referred to as a “runtime environment.” Also, source code compiled for a virtual machine is typically referred to as “bytecode.” In general, the virtual machine executes an application by generating instructions from the bytecode, that may then be performed by a physical processor available on the underlying computer system.

One well known example of a virtual machine is the Java® virtual machine, available from Sun® Microsystems. The Java® virtual machine consists of a bytecode instruction set, a set of registers, a stack, a garbage-collected heap (i.e. memory space for user applications), and a memory space for storing methods. Applications written in the Java® programming language may be compiled to generate bytecodes. The bytecodes provide the platform-independent code interpreted by the Java® virtual machine.

In practice, a computer system typically allocates a memory pool to each instance of a virtual machine executing on the system. Over time, memory available from the pool may grow or shrink as the virtual machine executes application programs. This occurs as the application programs allocate and free memory objects from the memory pool. In some cases, an application running on a virtual machine may attempt to allocate more memory than is available. For example, the memory used by an application may exceed the memory allocated to the virtual machine, or the virtual machine may exhaust the memory available from the underlying host system. When this occurs, an “out of memory” exception occurs. Such an out of memory exception may cause the application, the virtual machine, or the underlying system to crash. As a consequence of the crash, services provided by the application may cease functioning, unsaved data may be lost, and user intervention may be required to restart the system or applications.

One approach to prevent out of memory exceptions from occurring includes the use of a garbage collection process. Garbage collection refers to the automatic detection and freeing of memory that is no longer in use. For example, the Java® virtual machine performs garbage collection so that programmers are not required to free objects and other data explicitly. In practice, the virtual machine may be configured to monitor memory usage, and once a predefined percentage of memory is in use, invoke a garbage collector to reclaim memory no longer needed by a given application.

This process of reclaiming memory from applications executing on a virtual machine is referred to as a garbage collection cycle. One method of garbage collection is known as “tracing,” wherein the garbage collector determines whether a memory object is “reachable” or “rooted.” A memory object is considered reachable when it is still referenced by some other object in the system. If no running process includes a reference to a memory object, then the memory object is considered “unreachable” and a candidate for garbage collection. Typically, the garbage collector returns the unreachable memory objects to the heap (i.e., the memory space from which user applications may allocate memory) freeing up memory for applications running on the virtual machine. However, even using a garbage collector, applications may consume all of the memory available from the virtual machine, and consequently, trigger an “out of memory” exception.

Additionally, another approach to memory management includes having a system administrator monitor memory usage. Currently, an administrator may poll each instance of a virtual machine running on a system to determine their memory usage, and to identify any potential memory leaks. A “memory leak” is programming term used to describe the loss of available memory, over time. Typically, a memory leak occurs when a program allocates memory, but fails to return (or “free”) the allocated memory when it is no longer needed. Excessive memory leaks can lead to program failure after a sufficiently long period of time. However, memory leaks are often difficult to detect, especially when small, or when they occur in a complex environment where many applications are being executed simultaneously, making it difficult to pinpoint a memory leak to a single application. Further, this approach requires a system administrator to monitor the status of memory usage which may be both time consuming and prone to error. Furthermore, unless done frequently and consistently, an administrator may fail to detect a memory leak.

Accordingly, there remains a need in the art for methods to manage memory usage in garbage collected environments.

### SUMMARY OF THE INVENTION

The present invention generally relates to a method, a computer readable medium, and a computer system for predicting when an out of memory exception is likely to occur.

One embodiment of the invention provides a computer implemented method for managing memory use within a garbage collected computing environment. The method generally includes, during each of a plurality of garbage collection cycles, monitoring the amount of memory available from a memory pool for use by a plurality of applications, wherein each of the applications may dynamically allocate memory from, and return memory to, the memory pool. The method generally further includes generating a memory usage profile that characterizes changes in the memory available from the memory pool over two or more garbage collection cycles, and based on the memory usage profile, predicting whether an out of memory exception is likely to occur. A garbage collection cycle may be initiated when the amount of memory available in the memory pool reaches a predetermined amount.

Another embodiment of the invention includes a computer readable medium containing a program which, when executed, performs an operation for managing memory use within a garbage collected computing environment. The operations generally include, during each of a plurality of garbage collection cycles, monitoring the amount of memory available from a memory pool for use by a plurality of applications, wherein each of the applications may dynamically allocate memory from, and return memory to, the memory pool. The method generally further includes generating a memory usage profile that characterizes changes in the memory available from the memory pool over two or more garbage collection cycles, and based on the memory usage profile, predicting whether an out of memory exception is likely to occur.

Still another embodiment of the invention provides a computing device. The computing device generally includes a processor and a memory in communication with the processor. The memory contains at least a virtual machine program configured to predict when a future out of memory exception is likely to occur. The virtual machine program may be configured to perform, at least, the steps of allocating a memory pool for use by a plurality of applications, wherein each of the applications may dynamically allocate memory from, and return memory to, the memory pool. The steps may further include triggering a garbage collector process to perform a garbage collection cycle whenever the amount of memory available in the memory pool reaches a predetermined amount. The steps may still further include, during each garbage collection cycle, monitoring the amount of memory available from the memory pool, generating a memory usage profile that characterizes changes in the memory available from the memory pool over two or more garbage collection cycles, and based on the memory usage profile, predicting whether an out of memory exception is likely to occur.

### BRIEF DESCRIPTION OF THE DRAWINGS

So that the manner in which the above recited features of the invention can be understood, a more particular description of the invention, briefly summarized above, may be had by reference to the exemplary embodiments that are illustrated in the appended drawings. Note, however, that the appended drawings illustrate only typical embodiments of this invention and, therefore, should not be considered limiting of its scope, for the invention may admit to other equally effective embodiments.

FIG. 1 is a block diagram illustrating one embodiment of a computer system running a virtual machine.

FIG. 2 is a block diagram illustrating a virtual machine executing an application, according to one embodiment of the invention.

FIG. 3 is a block diagram illustrating one embodiment of a virtual machine.

FIG. 4 is a flowchart illustrating a method for predicting when out of memory events will occur, according to one embodiment of the invention.

FIG. 5 is a flowchart illustrating a method for collecting data to compile a memory profile, according to one embodiment of the invention.

FIG. 6 illustrates an embodiment of a memory profile data table.

FIG. 7 is an exemplary graphical representation of data collected by a memory profiler.

### DETAILED DESCRIPTION OF THE PREFERRED EMBODIMENTS

Embodiments of the present invention provide a method, system and article of manufacture for predicting when the memory usage of virtual machine in a garbage collected environment may cause an “out of memory” exception to occur.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

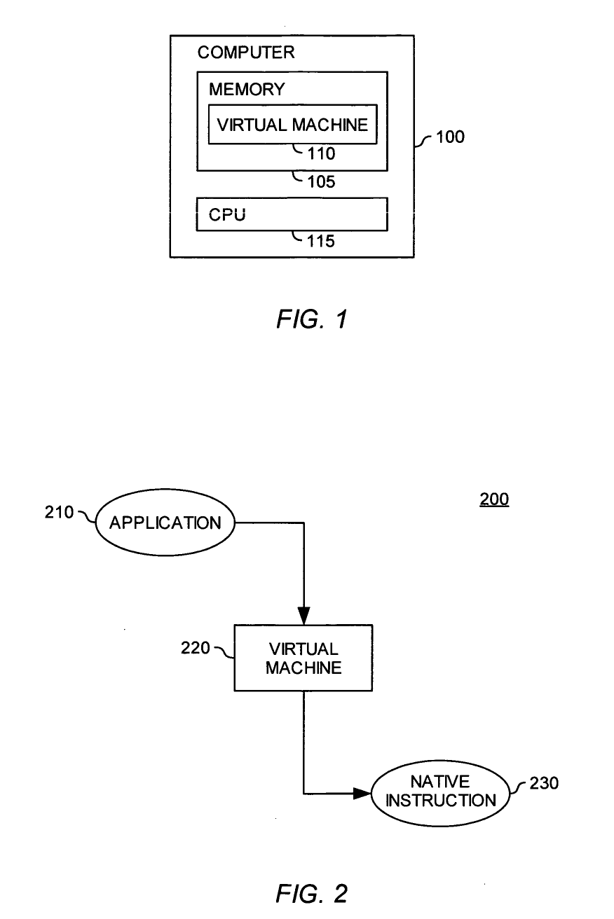

One embodiment of the invention is implemented as a program product for use with a computer system such as, for example, the computer system shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 is a block diagram illustrating a computer system 100 configured according to one embodiment of the invention. Illustratively, the computer system 100 includes memory 105 and a central processing unit (CPU) 115. Additionally, computer system 100 typically includes additional components such as non-volatile storage, network interface devices, displays, input output devices, etc. In one embodiment, computer system 100 may comprise computer systems such as desktop computers, server computers, laptop computers, tablet computers, and the like. However, the systems and software applications described herein are not limited to any currently existing computing environment or programming language, and may be adapted to take advantage of new computing systems and programming languages as they become available.

In one embodiment, one or more virtual machine(s) 110 may reside within memory 110. Each virtual machine 110 running on computer system 100 is configured to execute software applications created for the virtual machine 110. For example, the virtual machine 110 may comprise the Java® virtual machine and operating environment available from Sun Microsystems, Inc. (or an equivalent virtual machine created according to the Java® virtual machine specifications). Although embodiments of the invention are described herein using the Java® virtual machine as an example, embodiments of the invention may be implemented in any garbage collected application environment.

FIG. 2 is a block diagram further illustrating the operations of a virtual machine 220 executing an application 210, according to one embodiment of the invention. As described above, software applications may be written using a programming language and compiler configured to generate bytecodes for the particular virtual machine 220. In turn, the virtual machine 220 may execute application 210 by generating native instructions 230 from the bytecodes. The native instructions may then be executed by the (CPU) 115.

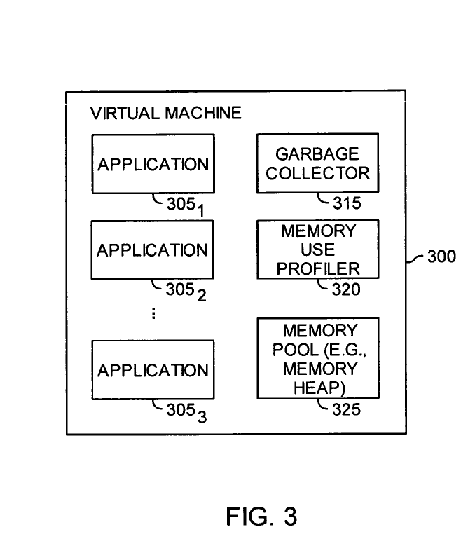

FIG. 3 is a block diagram further illustrating one embodiment of a virtual machine 300. Illustratively, virtual machine 300 includes a garbage collection process 315, a memory use profiler process 320, and available memory pool 325. Additionally, virtual machine 300 is shown executing a plurality of applications 305₁-305₃. Applications 305₁-305₃ are written in a programming language associated with the virtual machine 300 (e.g., the Java® programming language) and compiled into bytecodes that may be executed by virtual machine 300. In one embodiment, the virtual machine 300 may be may be configured to multi-task between multiple applications 305₁-305₃. Thus, although FIG. 3 illustrates three applications 305₁-305₃ executing on the virtual machine 300, at any given time, any number of applications 305 may be executing on the virtual machine 300.

While executing, the applications 305 may dynamically allocate memory from memory pool 325 (e.g., a heap structure). For example, the Java® programming language provides the “new” operator used to allocate memory from the heap at runtime. Other programming languages provide similar constructs. When an object is no longer referenced by an application 305, the heap space it occupies may be recycled so that the space is available for subsequent new objects. As described above, garbage collection is the process of automatically freeing memory allocated to such objects that are no longer referenced by an application 305.

In one embodiment, the garbage collector 315 may be configured to perform a garbage collection process or cycle. Performing a garbage collection cycle allows unused (but allocated) memory to be recycled. When an object is “collected” by the garbage collector 315, any memory allocated to the object may be returned to the memory pool 325. As described above, a memory pool 325 may include a heap structure from which applications 305 may allocate memory. Thus, when the garbage collector reclaims memory allocated to an object as “garbage” it is returned to the heap.

In one embodiment, the size of the memory pool 325 is determined using a fixed parameter specified for a given instance of virtual machine 300. As used herein, the size of memory pool 325 is represented as Mₘₐₓ. For a Java® virtual machine, Mₘₐₓ defines the size of a memory heap, in bytes. If the memory allocated by applications 305 exceeds Mₘₐₓ, an “out of memory exception” occurs. To recycle memory no longer needed by an application, the virtual machine 300 is configured to initiate garbage collector 315. A garbage collection cycle may be triggered whenever the applications 305₁-305₃ use a predefined percentage of Mₘₐₓ. During each garbage collection cycle, the garbage collector 315 attempts to free memory no longer in use by the applications 305₁-305ₙ.

In one embodiment, the garbage collector 315 frees memory by conservatively estimating when a memory object in the memory pool 325 (e.g., a heap) will not be accessed in the future. During each garbage collection cycle, the garbage collector 315 may examine each memory object allocated by one of applications 305. If the memory object may be accessed in the future (e.g., when an application 305 has a reference to the object), then the garbage collector 315 leaves the object intact. If a memory object will not be accessed in the future (e.g., when none of the applications 305 have a reference to the object), then the garbage collector 315 recycles the memory allocated to the object and returns it to memory pool 325. Sometimes, however, an application will maintain a reference to an unneeded object. In such a case, the garbage collector 315 cannot free this memory and return it to the memory pool 325.

For example, an application may have a “memory leak.” As stated earlier, a “memory leak” is a programming term used to describe the loss of memory over time. A “memory leak” may occur when an application allocates a chunk of memory but fails to return it to the system when it is no longer needed. For example, once memory allocated by an application is no longer needed, a well behaved application will free the allocated memory. In some cases, however, an application may fail to free allocated memory when it is no longer needed. Since the application still references the memory, the garbage collector cannot reclaim it during a garbage collection cycle. If an application continues to allocate memory objects and not release them, then eventually such a program will consume all of the memory allocated to the virtual machine, causing an “out of memory” exception to occur.

Many other situations may cause a memory leak. For example, a linked list or a hash table may contain referenced, but no longer needed objects. Another common way a memory leak occurs is using native methods provided by the Java® programming language. In native code, a programmer can explicitly create a global reference to an object. The global reference will never be recycled by the garbage collector until the global reference itself is removed. Thus, if a programmer neglects to delete the global reference, then a memory leak may result.

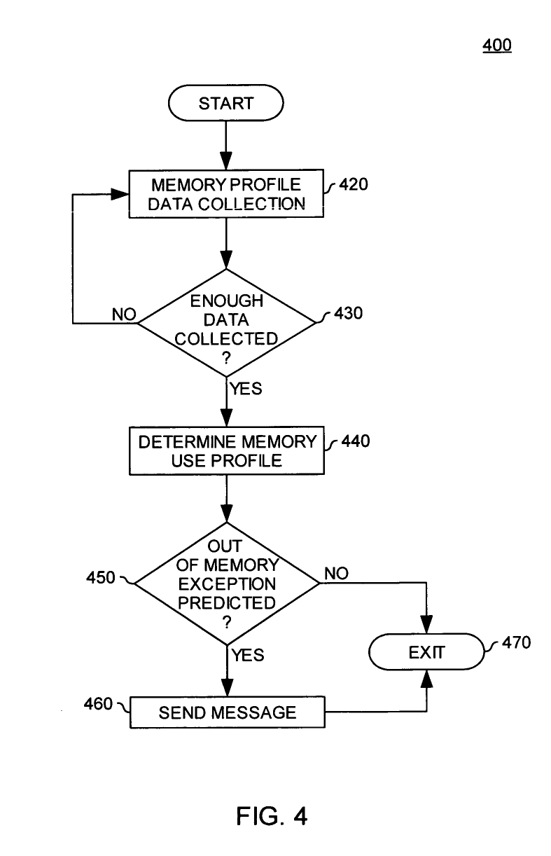

FIG. 3 also illustrates a memory use profiler 320. The memory use profiler 320 may be configured to generate a memory usage profile regarding the usage of memory from the memory pool. In one embodiment, the memory use profiler 320 is configured to determine whether an “out of memory” exception is likely to occur. If so, the memory use profiler 320 may be further configured to warn a system administrator or another application of a predicted “out of memory” exception, or perform some other remedial action. The operations of the memory use profiler 320 are further discussed in reference to FIGS. 4-7.

First, FIG. 4 illustrates the operations of a memory use profiler 320 to construct a memory use profile regarding memory pool 325. In one embodiment, the virtual machine 300 may initiate the method 400 as part of each garbage collection cycle performed by the garbage collector 315. At step 420, the memory use profiler 320 collects memory profile data. For example, the profiler 320 may determine how much memory each application 305 has allocated from the memory pool 325. Thus, during each garbage collection cycle, the profiler may obtain a snapshot of memory use. At step 430, the memory use profiler 320 determines whether a sufficient amount of data is available to construct a memory use profile. For example, the profiler 320 may be configured to collect memory use data for a minimum number of garbage collection cycles before constructing a memory use profile. If not, the memory use profiler 320 then returns to step 420, and waits to collect more data during subsequent garbage collection cycles. Otherwise, at step 440, the memory use profiler 320 generates a memory use profile.

In one embodiment, the memory profile is a collection of data points representing the memory usage of the virtual machine 300, the memory pool 325 and the applications 305, over time. Once the memory use profiler 320 collects an adequate amount of memory use data, the profiler 320 may be configured to construct a memory use profile. For example, the memory use profiler 320 may use the data points collected during each garbage collection cycle to perform a regression analysis. The more data points that are available, the more accurate the regression analysis may become. However, any appropriate statistical technique may be used to generate a memory use profile.

Depending on the actual memory use by applications 305, the constructed memory use profile may exhibit a linear or exponential memory usage profile. However, memory use may also follow other predictable patterns. For example, memory use may follow a polynomial or sinusoidal pattern. Regardless of the particular memory usage profile, the memory use profile is used to predict the future memory use of the applications 305 running on virtual machine 300. Using a linear regression, for example, a linear equation generated from memory profile data represents the rate at which applications 305 are consuming memory from pool 325, over time. If such an equation indicates that the amount of memory being used by the applications 305 is growing unabated (e.g., if the slope of a linear equation representing memory use is positive), then an “out of memory” exception may eventually occur, despite the actions of garbage collector 315 to free memory objects. In alternative embodiments, other techniques may be used to predict when an out of memory event may occur. For example, learning heuristics such as a neural net or machine learning techniques may be used to analyze the memory use profile data.

At step 450, the memory use profiler 320 determines whether an “out of memory” exception is likely to occur, based on the memory use profile constructed from memory use data. If so, a memory leak may be occurring. By using the memory use profile and the maximum amount of memory available to the virtual machine Mₘₐₓ, the memory use profiler 320 may be able to predict when an “out of memory” exception is likely to occur. If so, at step 460, the memory use profiler 320 may be configured to send a message to a system administrator indicating the when the predicted that “out of memory” event is likely to occur. If an “out of memory” exception is not predicted, then the method 400 terminates at step 470.

Depending on the memory use profile, and the configuration of the profiler 320, a variety of remedial actions may be performed. For example, if a memory leak exhibits a linear growth pattern, it may not become a critical problem for some time. In such a case, the memory profiler may simply notify a system administer via an automated email message. Alternatively, if a leak is exhibiting an exponential growth pattern, then a crash of the virtual machine 300 may be imminent. In this case, the profiler 320 may be configured to pursue more aggressive steps to contact an administrator (e.g., an instant message or mobile phone page), or the profiler 320 may have authority to terminate a process running on the virtual machine 300, allowing other applications 305 to continue to function at the expense of the application causing the memory leak. Another possibility includes requesting that the amount of memory allocated to the virtual machine be increased. Doing so may delay the time before an “out of memory execution” occurs.

Additionally, the memory use profiler 320 may also be configured to calculate a confidence level regarding a prediction of whether (or when) an “out of memory” event is likely to occur. In one embodiment, the memory use profiler 320 may be configured to determine a confidence level using the amount or quality of the memory profile data collected. For example, known statistical techniques may be used to determine how strongly a set of data points is correlated to a linear equation generated using a regression analysis. However, any appropriate statistical techniques may be used. The memory use profiler 320 may be configured to transmit an “out of memory” prediction (or perform some other remedial action) only when the prediction is above a specified quality threshold.

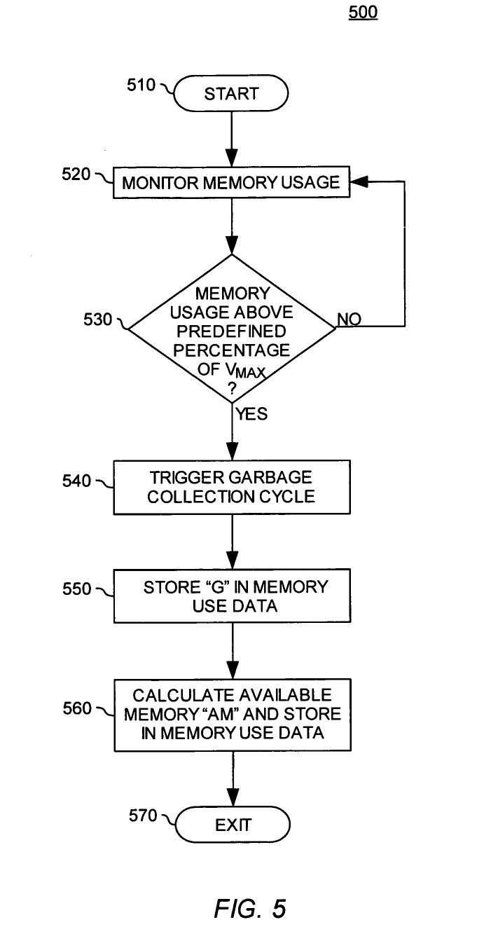

FIG. 5 illustrates a method 500 performed by the memory use profiler 320 to generate a memory use profile, according to one embodiment of the invention. The method 500 begins at step 510 and proceeds to step 520. At step 520 while applications 305 are executing, the virtual machine 300 monitors the memory within the virtual machine environment. For example, the virtual machine 300 may be configured to monitor the amount of free space remaining in the memory pool 325. While monitoring the memory usage, at step 530 the virtual machine 300 determines whether the free memory has fallen below a predefined percentage of Mₘₐₓ.

When this occurs, the virtual machine 300 triggers a garbage collection cycle performed by garbage collector 315. As described above, the garbage collector 315 inspects memory objects allocated by applications 305 and may be able to recycle, or “free” some of the allocated memory, returning it to memory pool 325. Doing so helps prevent the virtual machine 300 from experiencing an “out of memory” exception. However, in some circumstances the garbage collector 315 will be unable to return allocated (but no longer needed) memory objects back to the virtual machine. For example, one of applications 305 may have a “memory leak,” wherein the application 305 fails to return memory it no longer needs to memory pool 325. If the application 305 still references the allocated memory, the garbage collector 315 cannot return this memory to the memory pool 325. Further, if the application 305 continues to allocate memory objects, eventually the application 305 may consume all of the memory assigned to the virtual machine Mₘₐₓ causing an “out of memory” exception to occur.

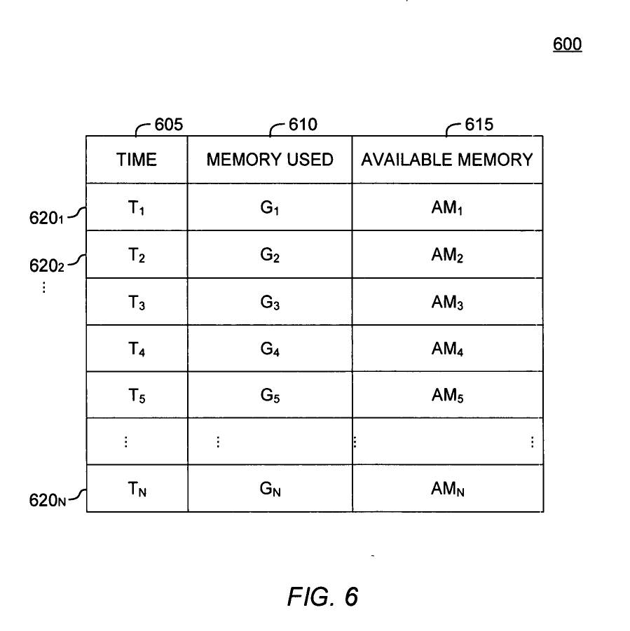

While memory usage is not above predefined percentage of Mₘₐₓ, the method 500 remains at step 520. At step 540, once memory usage is above this threshold, the virtual machine 300 triggers a garbage collection cycle performed by garbage collector 315. After each garbage collection cycle, the memory use profiler 320 may determine the size of memory allocated to applications 305 from memory pool 325. As used herein, this amount of memory is represented by the variable ‘g’. After the garbage collection cycle is complete, ‘g’ may be stored to a table storing the data points used to construct a memory use profile. One example of a data table is illustrated in FIG. 6. In an alternative embodiment, the memory use profiler 320 may be configured to collect memory use profile data prior to each garbage collection cycle performed by garbage collector 315.

Optionally, at step 560, the profiler 320 calculates the amount of free memory in memory pool 325 by subtracting amount of allocated memory, i.e., “g”, from the total amount of memory available from memory pool 325, i.e., Mₘₐₓ. This value is represented herein by the variable: “am” (short for “available memory”). The value for ‘am’ may be useful in an embodiment where the size of the memory heap allocated to virtual machine 300 may change, over time. Otherwise, the ‘am’ value may not be calculated with each garbage collection cycle, and instead may be calculated dynamically from the Mₘₐₓ value, and the ‘g’ value, when needed. If calculated, at step 560, profiler 320 records a value for ‘am’ in the memory use profile table. After completing a garbage collection cycle and recording memory use data, the method terminates at step 570.

FIG. 6 illustrates an embodiment of a memory profile data table 600. Within the table 600 are several rows of collected memory profile data. Each row 620₁-620ₙ includes multiple data elements stored by the columns of the table 600. Each row, 620₁-620ₙ, represents memory profile data collected during a garbage collection cycle performed by garbage collector 315. The column 605 contains the time when the virtual machine 300 triggered the garbage collector 315 to perform a garbage collection cycle. Column 610 contains the amount of memory that is being used by the virtual machine, i.e., a value for ‘g’, after each garbage collection cycle. If calculated, column 615 contains the amount of free memory available from memory pool 325, i.e., a value for ‘am’. The column 615 is calculated by subtracting ‘g’ from Mₘₐₓ.

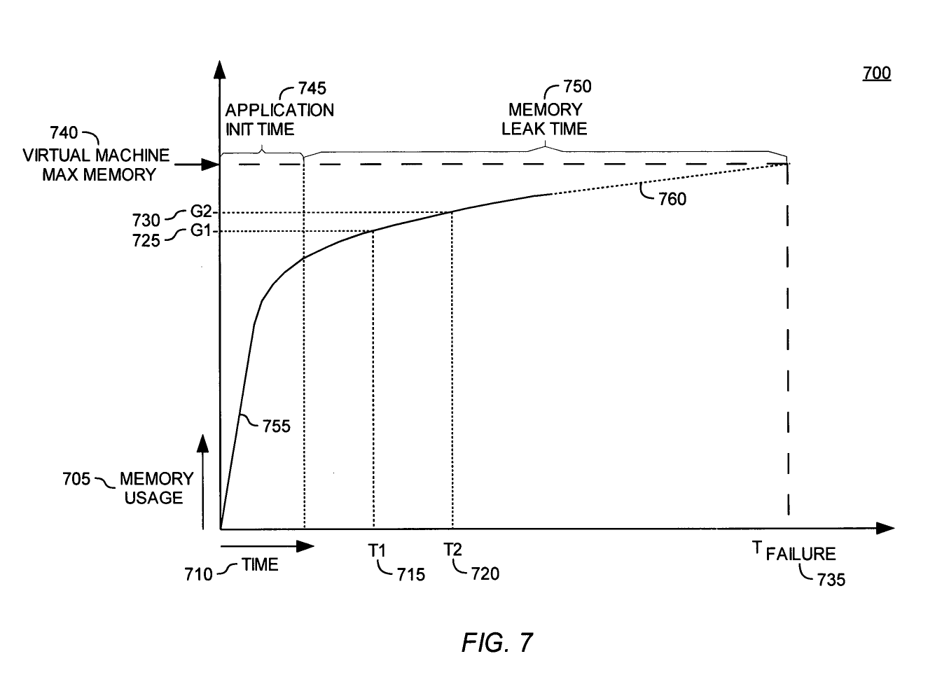

FIG. 7 illustrates a graph 700 of a memory use profile within a virtual machine, according to one embodiment of the invention. The graph 700 may be constructed from the memory profile data values in Table 6. Illustratively, the two dimensional graph 700 includes a horizontal axis 710 which represents time, and a vertical axis 705 which represents memory usage. Between the two axes is a solid line 755 representing the memory usage of a given instance of virtual machine 300.

Often, when an instance of a virtual machine 300 is first initiated and applications begin executing, the applications may allocate memory from memory pool 325 at a rapid pace. This is illustrated by the steep slope of the solid line 755 for initialization period 745. After the initialization period 745, the memory use of virtual machine 300 levels off. In some circumstances, the virtual machine 300 and the applications 305 may never consume all of the memory available from memory pool 325. However, if an application 305 has a memory leak, memory use may gradually increase, as shown in graph 700 by the gradual upward trending slope of the line 755 during the memory leak period 750.

When memory use within the virtual machine 300 reaches a predefined percentage of the Mₘₐₓ, the garbage collector 315 will perform a garbage collection cycle and attempt to recycle some of the memory currently allocated to applications 305. Illustratively, a first run of the garbage collector 315 occurs at time “t1.” At the same time, the amount of memory used “g1” 725 is recorded in table 600. At time t2, the garbage collector 315 performs a second garbage collection cycle, and memory use profiler 320 collects profile data point “g2” and stores this value in table 600. After multiple garbage collection cycles, a memory usage profile begins to emerge. As illustrated, the memory use profile is represented by line 755. In this illustration, the virtual machine 300 is experiencing a memory leak.

The memory use profiler 320 may use the data points collected during each garbage collection cycle to determine the future memory usage of the virtual machine 300. The expected graph of the memory usage is plotted on the graph using dotted line 760. This represents the predicted memory usage of virtual machine 300. Since the maximum memory available to the virtual machine 300 is known, (i.e., Mₘₐₓ 740), the memory usage profile can be used to determine when the virtual machine 300 will experience an “out of memory” exception; namely, The intersection of the line 755 with the horizontal line representing Mₘₐₓ 740 is the point in time which the virtual machine will experience an “out of memory” exception. The time of this intersection is shown on the graph as failure 735. This predicted time failure 735 of an “out of memory” exception can then be sent to the system administrator in the form of a message as was described above.

Thus, embodiments of the invention provide a method to predict when an “out of memory” exception is likely to occur. For example, memory usage data may be collected during each garbage collection cycle performed by a garbage collector. Using a set of data points so collected, a memory use profiler may determine if the memory usage is level, increasing at a constant rate, or increasing at an exponential rate. Depending on the severity and predicted growth rate of a memory leak, a variety of remedial actions may be taken.

Doing so allows a system administrator to intervene as necessary to prevent an ongoing memory leak from disrupting the activity of the system. At the same time, the administrator is free to focus on other tasks and not required to constantly monitor the memory usage of a garbage collected environment in order to detect any such memory leaks.

While the foregoing is directed to embodiments of the present invention, other and further embodiments of the invention may be devised without departing from the basic scope thereof, and the scope thereof is determined by the claims that follow.

What is claimed is:

1. A computer-implemented method for managing memory use within a garbage collected computing environment, comprising:
during each of a plurality of garbage collection cycles, monitoring the amount of memory available from a memory pool for use by a plurality of applications, wherein each of the applications may dynamically allocate memory from, and return memory to, the memory pool;
generating a memory usage profile based on the monitored amount of memory available from the memory pool, wherein the memory usage profile characterizes changes in the memory available from the memory pool over two or more garbage collection cycles; and
based on the memory usage profile, predicting whether an out of memory exception is likely to occur.

2. The method of claim 1, wherein the memory pool is allocated by a memory manager.

3. The method of claim 1, further comprising triggering a garbage collector process to perform each garbage collection cycle when the amount of memory available in the memory pool reaches a predetermined amount.

4. The method of claim 1, wherein the memory pool comprises a memory heap.

5. The method of claim 1, wherein garbage collected computing environment comprises a virtual machine environment.

6. The method of claim 1, further comprising, performing a remedial action to avert the predicted out of memory exception from occurring.

7. The method of claim 5, wherein the remedial action comprises sending a system administrator an indication of when the predicted out of memory exception is likely to occur.

8. The method of claim 1, wherein determining a memory usage profile comprises performing a statistical analysis based on the amount of memory allocated from the memory pool.

9. The method of claim 1, further comprising determining a confidence level associated with the prediction of whether the out of memory exception is likely to occur.

10. A computer readable medium containing a program which, when executed, performs an operation for managing memory use within a garbage collected computing environment, comprising:
during each of a plurality of garbage collection cycles, monitoring the amount of memory available from a memory pool for use by a plurality of applications, wherein each of the applications may dynamically allocate memory from, and return memory to, the memory pool;
generating a memory usage profile based on the monitored amount of memory available from the memory pool, wherein the memory usage profile characterizes changes in the memory available from the memory pool over two or more garbage collection cycles; and
based on the memory usage profile, predicting whether an out of memory exception is likely to occur.

11. The computer readable medium of claim 10, wherein the memory pool is allocated by a memory manager.

12. The computer readable medium of claim 10, further comprising triggering a garbage collector process to perform each garbage collection cycle when the amount of memory available in the memory pool reaches a predetermined amount.

13. The computer readable medium of claim 10, wherein the garbage collected computing environment comprises a virtual machine environment.

14. The computer readable medium of claim 10, wherein the operations further comprise, performing a remedial action to avert the predicted out of memory exception from occurring.

15. The computer readable medium of claim 14, wherein the remedial action comprises sending a system administrator an indication of when the predicted out of memory exception is likely to occur.

16. The computer readable medium of claim 10, wherein determining a memory usage profile comprises performing a statistical analysis based on the amount of memory allocated from the memory pool.

17. The computer readable medium of claim 10 wherein the operations further comprise, determining a confidence level associated with the prediction of whether the out of memory exception is likely to occur.

18. A computing device configured to manage memory use within a garbage collected computing environment, comprising:
a processor; and
a memory in communication with the processor containing at least a virtual machine program, wherein the virtual machine program is configured to predict when future out of memory exception is likely to occur by performing at least the steps of:
allocating a memory pool for use by a plurality of applications, wherein each of the applications may dynamically allocate memory from, and return memory to, the memory pool;
when the amount of memory available in the memory pool reaches a predetermined amount, triggering a garbage collector process to perform a garbage collection cycle;
during each garbage collection cycle, monitoring the amount of memory available from the memory pool;
generating a memory usage profile based on the monitored amount of memory available from the memory pool, wherein the memory usage profile characterizes changes in the memory available from the memory pool over two or more garbage collection cycles; and
based on the memory usage profile, predicting whether an out of memory exception is likely to occur.

19. The computing device of claim 18, wherein the operations further comprise, sending a system administrator an indication of when the predicted out of memory exception is likely to occur.

20. The computing device of claim 18, wherein determining a memory usage profile comprises performing a statistical analysis based on the amount of memory allocated from the memory pool.

21. The computing device of claim 18, wherein the operations further comprise, determining a confidence level associated with the prediction of when the out of memory exception is likely to occur.
